(19) United States
(12) Patent Application Publication
(10) Pub. No.: US 2010/0216510 A1
(43) Pub. Date: Aug. 26, 2010

(54) COMMUNICATION SYSTEM AND METHOD OF USING THE SAME

(75) Inventor: Tun-Ping Wang, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/391,620

(22) Filed: Feb. 24, 2009

(51) Int. Cl. H04B 1/38

(52) U.S. Cl. 455/558

(57) ABSTRACT

A communication system includes a phone device and an electronic card. The phone device includes a microprocessor, a dialing unit and an identifying unit connected with the microprocessor respectively. The identifying unit includes a reader and an induction antenna. The electronic card includes a tag antenna having a matching frequency with the induction antenna, and a memory unit storing a plurality of telephone numbers therein. The reader can wirelessly read the telephone numbers in the memory unit by means of the induction antenna and the tag antenna and further transmit the telephone numbers into the microprocessor. Then the dialing unit generates pulse signals according to the telephone numbers from the microprocessor and further sends the pulse signals out. A method of using the above-mentioned communication system includes: placing the phone device in an off-hook state, and placing the electronic card within an effective range of the identifying unit.

### BACKGROUND OF THE INVENTION

1. Field of the Invention

The present invention generally relates to a communication system and a method of using the same, and more particularly to a communication system capable of automatically dialing and a method of using the same.

2. The Related Art

With the development of electronic technology, a phone is generally used in our daily life as a communication means. Accordingly, a great quantity of telephone numbers comes with the tide of fashion. At present, each telephone number is made up of a string of Roman numerals. A conventional dialing method is accomplished mainly by manually dialing the corresponding telephone number. For example, a telephone call can be made either by dialing the Roman numerals of the corresponding telephone number one by one in the phone, or by selecting the telephone number from the phone book to dial directly. However, it is inconvenient for an old person or a child to manually operate dialing the telephone number for the telephone call. Therefore, a communication system capable of automatically dialing is required.

### SUMMARY OF THE INVENTION

An object of the present invention is to provide a communication system including a phone device and an electronic card. The phone device includes a microprocessor, a dialing unit, a transmitter, a receiver and an identifying unit connected with the microprocessor respectively. The identifying unit includes a reader and an induction antenna. The electronic card includes a tag antenna having a matching frequency with the induction antenna of the identifying unit, and a memory unit storing a plurality of telephone numbers therein. Wherein the reader of the identifying unit can wirelessly read the telephone numbers stored in the memory unit of the electronic card by means of the induction antenna and the tag antenna and further transmit the telephone numbers into the microprocessor, then the dialing unit can generate pulse signals according to the telephone numbers from the microprocessor and further send the pulse signals out.

A method of using the above-mentioned communication system includes the steps of: placing the phone device of the communication system in an off-hook state, and placing the electronic card within an effective range of the identifying unit, wherein it is the effective range that is covered by an electromagnetic field generated by the induction antenna of the identifying unit.

As described above, the electronic card and the identifying unit can be wirelessly connected with each other by means of the induction antenna and the tag antenna in the effective range so that the phone device can wirelessly read the telephone numbers stored in the electronic card and further dial the telephone numbers automatically by means of the microprocessor and the dialing unit. Therefore, it is convenient for an old person and a child to make a phone call.

### BRIEF DESCRIPTION OF THE DRAWINGS

The present invention will be apparent to those skilled in the art by reading the following description of a preferred embodiment thereof, with reference to the attached drawings, in which:

FIG. 1 is a block diagram of a communication system according to a first embodiment of the present invention; and

FIG. 2 is a block diagram of a communication system according to a second embodiment of the present invention.

### DETAILED DESCRIPTION OF THE PREFERRED EMBODIMENT

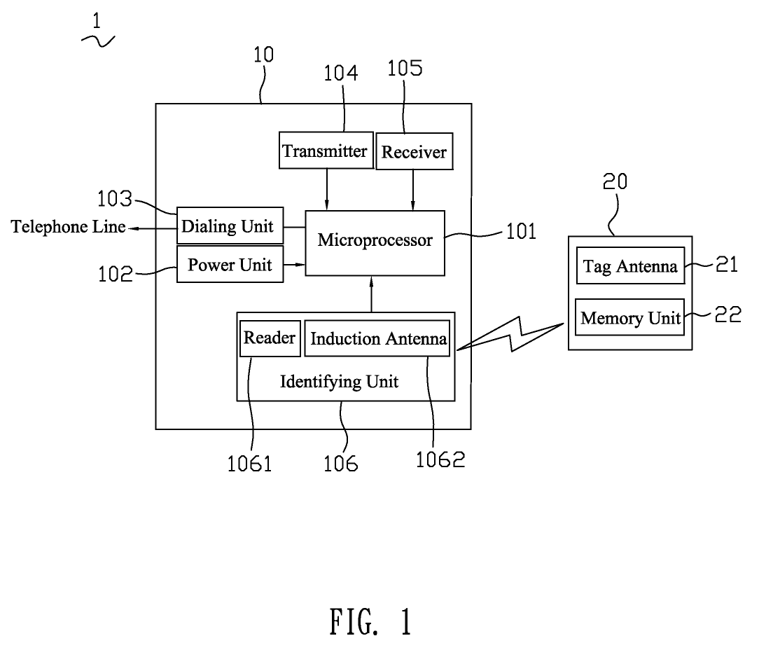

With reference to FIG. 1, a communication system 1 according to the first embodiment of the present invention includes a phone device 10 and an electronic card 20 capable of wirelessly inducing with the phone device 10 within an appropriate range. The phone device 10 includes a microprocessor 101, a power unit 102, a dialing unit 103, a transmitter 104, a receiver 105 and an identifying unit 106 connected with the microprocessor 101 respectively so as to be operated and controlled to accomplish a communication.

The power unit 102 supplies a work voltage to the phone device 10 so as to maintain a normal work of the communication system 1. The power unit 102 is an independent battery or an exterior power supply connected to a transformer (not shown). The dialing unit 103 connected with the microprocessor 101 can generate pulse signals according to the telephone numbers from the microprocessor 101, and furthermore, can transmit the pulse signals by means of a telephone line so as to make a telephone call. The transmitter 104 may be a microphone in order to send out a sound from a user, and the receiver 105 may be a loudspeaker for amplifying another sound received by the phone device 10 so as to facilitate for listening.

The identifying unit 106 is a wireless identifying module, it includes a reader 1061 and an induction antenna 1062. The induction antenna 1062 can generate an electromagnetic field thereabout so as to wirelessly connect the electronic card 20. The identifying unit 106 can be various kinds of wireless chips, such as a Bluetooth chip or a radio-frequency identification (RFID) chip etc. In this embodiment, the identifying unit 106 is a NFC (near field communication) chip. The electromagnetic field generated by the NFC chip can cover a range of 10 centimeters.

The electronic card 20 is a RF identifying tag connected with the identifying unit 106. In the embodiment, the electronic card 20 is a NFC tag capable of being wirelessly induced by the identifying unit 106 in the electromagnetic field. The electronic card 20 includes an induction circuit (not shown), a tag antenna 21 and a memory unit 22. The memory unit 22 can store telephone numbers therein. The tag antenna 21 has a matching frequency with the induction antenna 1062 of the identifying unit 106 so that the reader 1061 of the identifying unit 106 can wirelessly read the telephone numbers stored in the memory unit 22 of the electronic card 20, and then transmit the telephone numbers into the microprocessor 101 of the phone device 10. Some conspicuous indicating information will be marked on the electronic card 20 and corresponds the telephone numbers with the indicating information in the electronic card 20 so as to facilitate the telephone numbers to be identified. For example, the indicating information is a name, a hypocorism or a photo corresponding to the telephone numbers in the electronic card 20 and so on.

A method of using the above-mentioned communication system 1 for automatically dialing is described hereinafter. The method includes the following steps: step 1, place the phone device 10 in an off-hook state; step 2, select the electronic card 20 according to the indicating information marked thereon, and then place the selected electronic card 20 within the effective range of the identifying unit 106. At this moment, the electromagnetic field generated by the induction antenna 1602 activates the corresponding induction circuit in the electronic card 20 by means of the corresponding tag antenna 21 so as to make the phone device 10 and the electronic card 20 wirelessly connected with each other. Therefore, the reader 1061 of the identifying unit 106 can identify and read the telephone numbers stored in the memory unit 22 of the electronic card 20, and then transmit the read telephone numbers to the microprocessor 101. Then the microprocessor 101 sends the telephone numbers to the dialing unit 103. The dialing unit 103 generates corresponding pulse signals according to the telephone numbers and further sends the pulse signals out by means of the telephone line so as to accomplish an automatic dialing. In the above-mentioned method, the step 1 and the step 2 can be exchanged with each other.

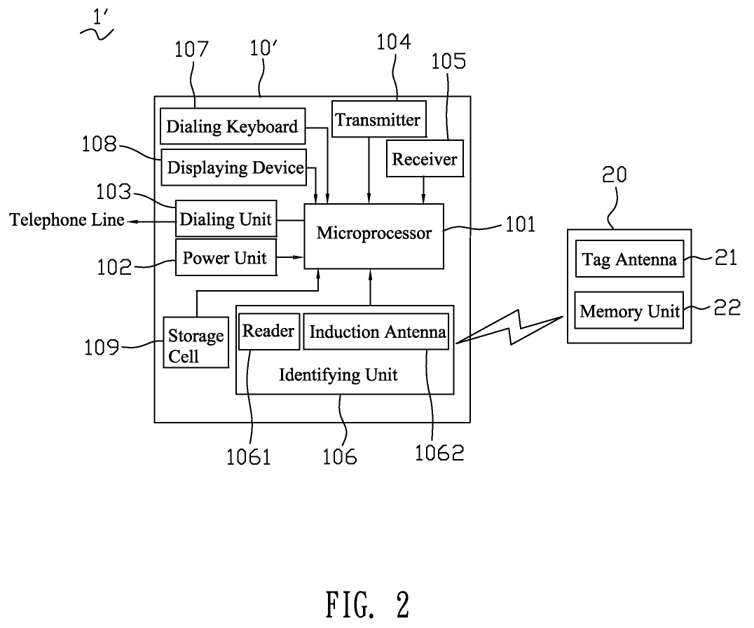

Referring to FIG. 2, a communication system 1′ according to the second embodiment of the present invention is shown. Comparing to the first embodiment, the differences are that a phone device 10′ of the communication system 1′ further includes a dialing keyboard 107, a displaying device 108 and a storage cell 109 connected with a microprocessor 101 of the communication system 1′ respectively.

The dialing keyboard 107 can be used to manually dial telephone numbers. The storage cell 109 is used to store telephone numbers therein as an electronic phone book, wherein the telephone numbers read by an identifying unit 106 of the communication system 1′ from a corresponding electronic card 20 can also be stored in the storage cell 109. Furthermore, the telephone numbers dialed by means of the dialing keyboard 107 and read by the identifying unit 106 from the corresponding electronic card 20 can be displayed on the displaying device 108 so as to check if the dialed telephone numbers are correct.

A method of using the foregoing communication system 1′ for automatically dialing is substantially the same with the method in the first embodiment, so it is not further described.

As described above, the electronic card 20 is defined to correspond to the identifying unit 106 and can be wirelessly connected with the identifying unit 106 in the effective range so that the phone device 10/10′ can wirelessly read the telephone numbers stored in the electronic card 20 and further dial the telephone numbers automatically by means of the microprocessor 101 and the dialing unit 103. Therefore, it is convenient for an old person and a child to make a phone call.

What is claimed is:

1. A communication system, comprising:
a phone device including a microprocessor, a dialing unit, a transmitter, a receiver and an identifying unit connected with the microprocessor respectively, the identifying unit including a reader and an induction antenna; and
an electronic card including a tag antenna having a matching frequency with the induction antenna of the identifying unit, and a memory unit storing a plurality of telephone numbers therein;
wherein the reader of the identifying unit can wirelessly read the telephone numbers stored in the memory unit of the electronic card by means of the induction antenna and the tag antenna, and further transmit the telephone numbers into the microprocessor, then the dialing unit can generate pulse signals according to the telephone numbers from the microprocessor and further send the pulse signals out.

2. The communication system as claimed in claim 1, wherein the identifying unit is a NFC (near field communication) chip and the electronic card is a NFC tag corresponding to the NFC chip.

3. The communication system as claimed in claim 1, wherein the phone device further includes a displaying device connected with the microprocessor, the telephone numbers read by the identifying unit from the electronic card can be displayed on the displaying device.

4. The communication system as claimed in claim 1, wherein the phone device further includes a storage cell connected with the microprocessor, the telephone numbers read by the identifying unit from the electronic card can be stored in the storage cell.

5. The communication system as claimed in claim 1, wherein some indicating information is marked on the electronic card and corresponds to the telephone numbers stored in the electronic card for facilitating the telephone numbers to be identified.

6. The communication system as claimed in claim 5, wherein the indicating information is a user name, a user hypocorism or a user photo corresponding to the telephone numbers stored in the electronic card.

7. A method of using the above-mentioned communication system, comprising the steps of:
placing the phone device of the communication system in an off-hook state; and
placing the electronic card within an effective range of the identifying unit, wherein it is the effective range that is covered by an electromagnetic field generated by the induction antenna of the identifying unit.
